(19) United States
(12) Patent Application Publication
(10) Pub. No.: US 2009/0019541 A1
(43) Pub. Date: Jan. 15, 2009

(54) Sequence-acitvated applications

(75) Inventor: Wilhelmus Franciscus Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/582,063

(22) PCT Filed: Nov. 30, 2004
(86) PCT No.: PCT/IB04/52596

§ 371 Date: Jun. 8, 2006

(30) Foreign Application Priority Data
Dec. 9, 2003 (EP) 03104596.6

(51) Int. Cl. G06K 19/00

(52) U.S. Cl. 726/19

(57) ABSTRACT

A device (1; 1′) or an application (3) may be activated by supplying a series of activation codes. The device checks whether each code is received in a predetermined order and within a certain time period. If the check fails, the device or the application may be terminated. The codes may be stored on tokens (2), such as cards or optical information carriers. The device or the application may be a toy, such as a virtual or mechanical pet.

The present invention relates to applications that may be activated by activation codes. More in particular, the present invention relates to a device arranged for receiving activation codes and a method of receiving activation codes.

It is well known to activate applications, such as software programs or specific functions of certain devices, by supplying one or more codes. Such codes can be passwords or specific commands that activate the application. If the particular code is not received, the program will not run or the specific function of the device will not be activated. Examples of such known methods of activating applications are found, for example, in the field of computers where software programs may be activated using a unique command and/or a password, automatic teller machines where a password provides access to a service, cars which require the driver to key in a code to enable the starting motor, etc.

In the field of toys it is known to provide activation codes to robots in order to activate special functions. So-called Rumble Robots™ are provided with bar code readers for reading bar codes printed on cards, each bar code representing the activation code for a special function of the robot, such as greater strength or special skills. After the expiry of a certain time period, the special function is automatically de-activated and a new card has to be read if the special function is to be re-activated. Reference is made to http://www.howstuffworks.com/rumble-robot.htm where Rumble Robots™ are explained in more detail.

The exemplary activation codes mentioned above activate the application either for an unspecified amount of time (computer program, car) or for a limited amount of time (robots). In many cases, there is a need to control the duration of the activation and to only allow an extended activation if certain conditions are met. In the time-limited example discussed above the activation ends after a certain time period, and the application can only be re-activated using the same or a similar card.

It is often commercially desirable to make a user of a device use a whole range of activation codes rather than just one or only a few activation codes. This gives the producer (or provider) of the application a greater control over the actions of the user and ensures that more different activation codes are used. It will be clear that in the case of secure applications, the use of a plurality of activation codes allows a greater degree of security than the use of only a single or a small number of activation codes.

It is an object of the present invention to overcome these and other problems of the prior art and to provide a device and a method that require the user to utilize a greater number of activation codes.

Accordingly, the present invention provides a device arranged for receiving activation codes and carrying out a check, for each activation code, whether the code was received in a predetermined order and within a certain time period, the device further being arranged for de-activating an application if the check fails.

By checking whether each activation code is received in a predetermined order it is assured that only a well-defined sequence of codes can keep the application activated. Other sequences will cause the application to be de-activated.

By checking whether the codes are received within a certain time period it is assured that the codes are to be received by the device at a certain rate or at least within a certain time. This avoids that receiving the codes, and thus checking their order, takes an indefinite amount of time.

The check fails if the codes are not received in the predetermined order or if the codes are not received within a certain time period. This results in the de-activation of the application concerned or at least in the cessation of its activation. The de-activation may be immediate or gradual.

In other words, the present invention provides a device arranged for receiving activation codes and carrying out a check, for each activation code, whether the code was received in a predetermined order and within a certain time period, the device further being arranged for re-activating an application if the check is successful.

Preferably, the activation codes comprise strings of alphanumeric characters. The codes may thus each consist of a set of letters and/or numbers. The activation codes may comprise identifiers, which could also be constituted by alphanumeric characters, for identifying the code itself, the type of code, a version number, and/or other features. Each code is unique so that it can be checked against the predetermined order.

The order of the codes may be checked in several ways. The activation codes may each contain a serial number, and the device may check this number and compare it with the last serial number accepted by the device (the default serial number when checking the first number of a sequence being 0 or 1). In such an embodiment, consecutive activation codes have consecutive serial numbers. It is also possible for each activation code to contain a apparently random but unique identification (sequence) number. All unique identification numbers are stored in a table that determines the sequence of the numbers.

It is noted that the activation codes may be simple concatenations of identification numbers, serial numbers etc., however, it is possible for the activation codes to be encrypted so that the identification number cannot be readily recognized without knowledge of the cryptographic process and any key involved.

In a particularly advantageous embodiment, the application controls the device itself. That is, the de-activation of the application results in the de-activation of the device itself. However, many applications can be envisaged that leave the device running.

Although the activation codes could be entered into a keyboard as strings of characters and thus be received by the device, it is preferred that the device according to the present invention is further arranged for receiving the activation codes by reading at least one token. Such a token or information carrier comprises a substrate on which the activation code is registered. Preferably, each token contains one activation code. However, embodiments can be envisaged in which each token contains two, three or possible more than three activation codes.

In an advantageous embodiment, the token is an optical information carrier, such as a CD or a DVD. Optical information carriers allow a large amount of additional information to be registered, in addition to the activation code. A particularly advantageous information carrier is the so-called SFFO (Small Form Factor Optical) disc. Such an information carrier is both extremely compact (typically only about 3 cm) and inexpensive yet is capable of storing vast amounts of information, if necessary.

The present invention also provides a toy comprising a device as defined above. That is, the toy may be activated by activation codes and will be de-activated in the absence of correct activation codes. Such a toy may be an artificial pet, such as a virtual pet or a mechanical pet. A virtual pet “lives” in a device, such as a mobile telephone, while a mechanical pet has its own mechanical body. Both types of pet may advantageously be designed in accordance with the present invention.

As stated above, virtual pets may be applications running in devices such as computers, mobile telephones and other suitable devices. Accordingly, the present invention also provides a mobile telephone set comprising a device as defined above.

The present invention further provides an optical information carrier for use in a device as defined above, as well as a method of de-activating an application or a device, the method comprising: receiving activation codes, carrying out a check, for each activation code, whether the code was received in a predetermined order and within a certain time period, and de-activating the application or the device if the check fails.

In the method of the present invention the device may receive an activation code by reading a token, the token preferably being an optical information carrier such as an SFFO disc.

The present invention will further be explained below with reference to exemplary embodiments illustrated in the accompanying drawings, in which:

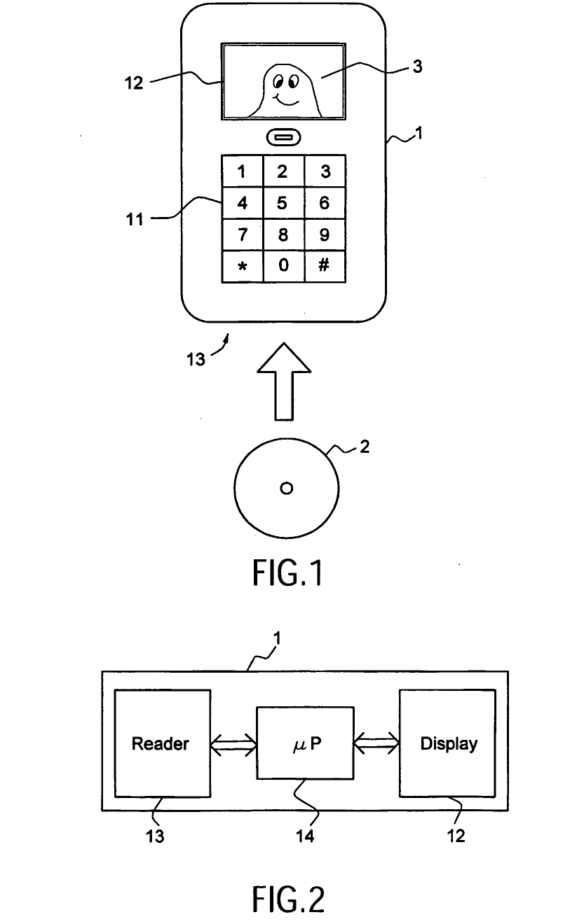

FIG. 1 schematically shows a first embodiment of a device according to the present invention.

FIG. 2 schematically shows a functional diagram of the embodiment illustrated in FIG. 1.

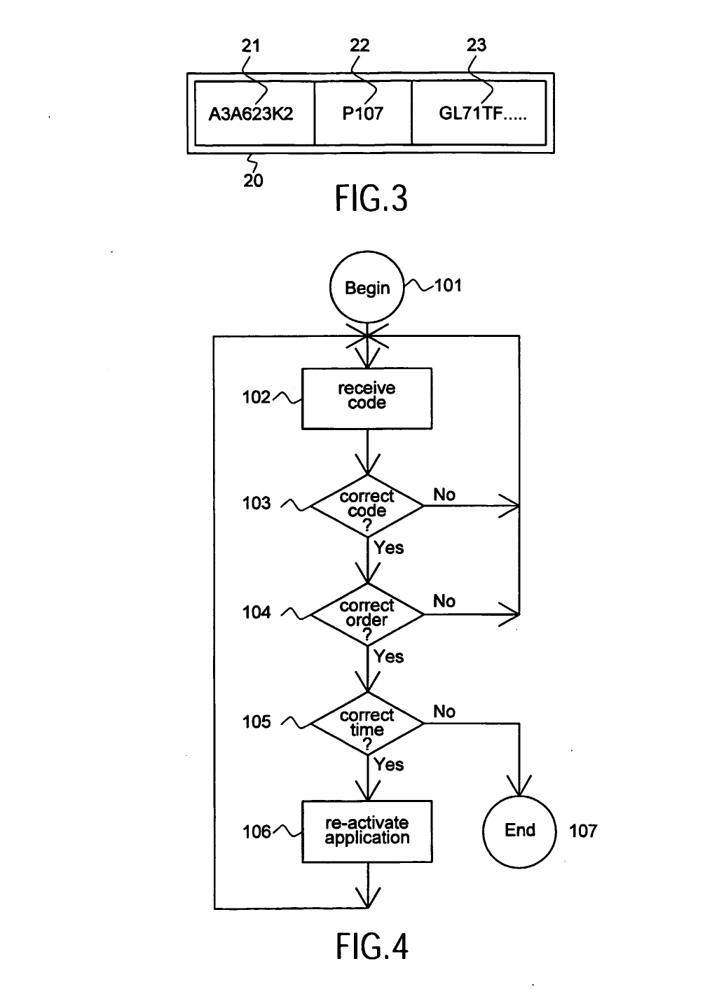

FIG. 3 schematically shows an activation code in accordance with the present invention.

FIG. 4 schematically shows a flow diagram representing a method according to the present invention.

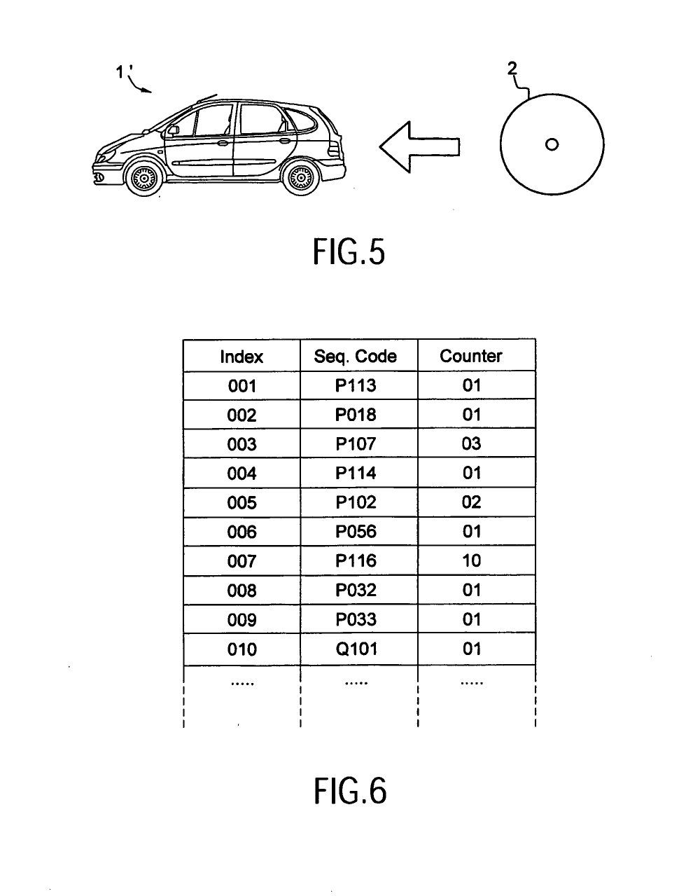

FIG. 5 schematically shows a second embodiment of a device according to the present invention.

FIG. 6 schematically shows a table for managing sequences as may be used in the present invention.

The mobile telecommunications device 1 shown merely by way of non-limiting example in FIG. 1 comprises a keyboard 11, a display screen 12 and a disc reader 13 (not shown in FIG. 1). An optical disc 2 can be inserted in the disc reader 13. In the embodiment shown, the disc is an SFFO (Small Form Factor Optical) disc. However, various other information carriers could be used instead, such as memory cards containing semiconductor memory, cards on which bar codes are printed, and other suitable tokens.

The keyboard 11 serves to enter information and to control the device 1. The display 12 may be used to display various kinds of information, pictures, and also a virtual pet 3.

The functioning of the device 1 is explained in more detail with reference to the schematic diagram of FIG. 2 where the token reader (disc reader) 13 is shown to be coupled with a processing unit 14 and the display 12. The disc reader 13 preferably is a reader suitable for reading (and possibly also writing) SFFO discs or other optical information carriers. It is noted that instead of a disc reader, another type of token reader could be used, such as a bar code reader, a memory card reader, a smart card reader, etc.

The processing unit 14 preferably comprises a microprocessor (P) for executing suitable software programs for controlling the device 1. In addition to controlling the device, the processing unit 14 is capable of supporting other applications, that is, other software programs. One such software program generates and controls the virtual pet 3 shown in FIG. 1.

The virtual pet 3 is a software character that may interact with the user by asking for food and attention. This “asking” may involve producing sounds through the device 1, while giving attention may involve pressing keys of the keyboard 11. In accordance with the present invention, giving food involves supplying a token (information carrier) 2 on which information relating to the pet is registered. This information is read by the token reader 13 and processed by the processing unit 14. Any response of the pet (3 in FIG. 1) is displayed on the display screen 12. This information comprises an activation code that serves as “food” for the virtual pet and keeps the pet alive. A starving pet may eventually die.

In accordance with the present invention the token (2 in FIG. 1) contains an activation code 20 which is schematically represented in FIG. 3. The exemplary activation code 20 of FIG. 3 may contain several fields. A first field contains an identification code 21 consisting of a unique string of alphanumeric characters that identifies the virtual pet. This identification code 21 allows the application controlling the virtual pet to check whether the activation code 20 matches the pet. This identification code 21 allows the producer of the virtual pets to provide unique “pet food” for each individual pet or for each type of pet. Additionally, or alternatively, the identification code 21 can be used to identify the provider (producer) of the virtual pet, thus allowing to distinguish between pets of different producers.

The second field contains a string of alphanumeric characters that is unique to this particular activation code. This sequence code 22 may contain a serial number, such as 107, if these codes are sequentially numbered. In addition, the sequence code 22 may contain a version number, such as P. It should be noted that the sequence codes 22 need not be sequentially numbered and may form pseudo-random numbers as long as some order has been assigned to these sequence codes. For example, the sequence codes could be generated using a pseudo-random generator (PRG) and, after being checked for uniqueness, be stored in a table. The table index then uniquely defines the order of the sequence codes. In some embodiments a sequence code may appear more than once in a table, thus allowing the associated activation code more than once.

For the sake of simplicity it will be assumed that the sequence codes 22 are serial numbers. This implies that the sequence code “P107” shown in FIG. 3 may in accordance with the present invention only be used after “P106” and before “P108”. The application therefore checks whether the previous sequence code that was accepted was “P106”, if this is not the case (for example because the previous code was “P105”) the code “P107” is rejected. Thus, the sequence codes can only be accepted in a predetermined order. This ensures that all activation codes of a series of codes are used, as no intermediate codes can be “skipped”.

According to a further aspect of the present invention, the device 1 also checks whether any subsequent activation codes are received within a certain time period. This ensures that activation codes are actually used and that no indefinite amounts of time elapse between the points in time when subsequent activation codes are accepted. If no activation code is accepted within a certain time period, the check fails and the application concerned (in the present example: the virtual pet) is de-activated.

The (optional) third field of the activation code 20 contains a script for controlling the application (in the present example the virtual pet). This script will later be explained in more detail.

An embodiment of the method of the present invention is illustrated in FIG. 4. In this embodiment, it is assumed that the application automatically ends, that is de-activates itself, if it is not re-activated in time. Of course other embodiments are possible in which the application has to be actively terminated.

The method of FIG. 4 is initiated in step 101. In step 102, an activation code is received by the device (1 in FIG. 1). Subsequently, in step 103, the device checks whether the code is “correct”, that is, whether the code is appropriate for the application concerned. This first check may be carried out by comparing the identification code (21 in FIG. 3) with a code stored in the device. It is noted that the device may contain more than one application capable of receiving activation codes and that the identification code (21 in FIG. 3) may be used to distinguish between applications.

If the first check is successful and the identification code is found to be correct, the routine continues with step 104. If the check fails, the routine returns to step 102.

In step 104 the device checks whether the activation code was received in the correct order. That is, the device compares the sequence code (22 in FIG. 3) of the present activation code with the sequence code of the previous activation code that may be stored in the device for this purpose. As mentioned above, the order may be derived from the activation code itself (that is, “106” precedes “107”) or from a table in which the individual codes are stored. If the code is found to be correct, the routine continues with step 105. If the check of step 104 fails, the routine returns to step 102.

In step 105 the device checks whether the activation code was received and accepted within a certain period of time. This period of time is preferably predetermined but may be variable, for example in dependence of the rate at which previous activation codes have been accepted. If the code is accepted within the prescribed period of time the routine continues with step 106, but if this third check fails the routine ends at step 107, resulting in the eventual de-activation of the application concerned.

It is noted that the de-activation of an application may be immediate or gradual. For example, in the case of the starving pet mentioned above the de-activation is preferably gradual, the pet's capabilities diminishing over time until it finally “dies”, that is, is completely de-activated.

In step 106, the application concerned is re-activated. The re-activation preferably involves prolonging the activation. However, it is also possible to re-activate an application by making an application active which previously had been inactive. It will be understood that in the case of artificial pets the step of making a previously inactive (“dead” or “unborn”) pet active may be subject to conditions.

After re-activating the application, the routine resumes in step 102 where a new code is received. It will be understood that various modifications are possible and that, for example, additional steps could be inserted which warn the user against the expiry of the time limit checked in step 105.

The script 23 of FIG. 3 is an optional part of the activation code 20. The script may contain instructions for controlling the application. In the case of a virtual pet, the script may influence the behavior of the pet and may, for instance, add new features or update existing features. The SFFO discs mentioned above are particularly suitable for using as a token in the present invention as these discs have a very large storage capacity, therefore allowing large scripts to be stored in addition to the activation code.

The device 1′ shown in FIG. 5 is a toy car in which a token can be inserted. In the embodiment shown, the token is an optical disc, preferably an SFFO disc, on which an activation code is stored. The activation code allows the device I′ to be re-activated in accordance with the present invention.

The exemplary table of FIG. 6 serves to manage sequences, in particular when the sequence numbers (22 in FIG. 3) do not directly correspond to the predetermined sequence. The table of FIG. 6 comprises three columns: an index column, a sequence code column and a counter column. The counter column is optional, other columns may be added if needed.

The index column contains an index that determines the sequence in which the activation codes are to be accepted. In the example shown the indices are numbered 001, 002, 003, etc., although other numberings may be used, such as 10, 20, 30, . . . . The sequence codes listed the next column may have any desired order, as the indices determine the order of the activation codes. Thus P113 may precede P018, and P107 is in the example shown not followed by P106.

As can be seen, the index 008 refers to two sequence codes: P032 and P033. This implies that the order in which P032 and P033 may be received is arbitrary, both are to be received after P116 (index 007) and before Q101 (index 009). In this way, a less strict order may be used. In some embodiments of the invention, the next index (in the present example 009) may be used if only one of P032 and P033 has been accepted, thus allowing the other activation code having the same index to be skipped. Other embodiments may require both activation codes having the same index to be accepted before an activation code corresponding with the next index can be accepted.

Conversely, an activation code may appear more than once in the table, preferably being associated with different indices for different entries. This allows activation codes to be re-used which may be advantageous when tokens are used to activate toys.

The counter in the third column may indicated the number of times an activation code may be accepted. Typically this number equals 1, but higher counter values may also be used, for example 3, indicating that this activation value may be accepted three times. This allows the activation codes, and any tokens on which they are represented, to be re-used to a limited extent. It is preferred that after each acceptance of a activation code, the corresponding counter value in the table is reduced by one, a counter value of zero indicating that the activation code can no longer be accepted and that the next activation code (as defined by the index value) must be used.

Still further embodiments can be envisaged which do not utilize a table but where the next sequence code (22 in FIG. 3) is indicated in the script (23) associated with a particular activation code, resulting in “chained codes”. This also allows the “predetermined” order to be compiled during the issuing of the activation codes: when issuing the first activation codes of a chain it may not be necessary to determine all activation codes of that chain of codes. In such an embodiment, the script could contain more than one sequence code, the particular sequence code to be used depending on certain conditions, such as the state of the application (for instance the health of the virtual pet). In addition, the script could contain part of the software program that controls the application. By accepting activation codes, for example by reading tokens, additional software programs (or parts of software programs) may be added to the application. Embodiments can be envisaged in which the application is initially not complete but may be completed by accepting suitable activation codes, the acceptance of which is controlled by their order.

A special activation code may be available for re-setting the application if needed. The device may be arranged for recognizing such a special activation code (for example in step 103 of the diagram of FIG. 4) and resetting any application, or any numbers and codes used in an application, accordingly.

If tokens are used to convey the activation codes it is advantageous if the tokens are re-writable, thus allowing the activation code stored on the token to be altered or erased, avoiding any re-use of the token. It is noted that the SFFO discs mentioned above may be re-writable.

The present invention is based upon the insight that an ordered sequence of activation codes may be used to maintain the activation of an application, such as an artificial pet. The present invention benefits from the further insight that activation codes may advantageously be stored on optical information carriers such as so-called SFFO discs.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents. The word “a” or “an” preceding an element does not exclude the presence of a plurality of such elements. Any reference signs do not limit the scope of the claims.

It will be understood by those skilled in the art that the present invention is not limited to the embodiments illustrated above and that many modifications and additions may be made without departing from the scope of the invention as defined in the appending claims.

1. A device (1) arranged for receiving activation codes (20) and carrying out a check, for each activation code, whether the code was received in a predetermined order and within a certain time period, the device further being arranged for de-activating an application if the check fails.

2. The device according to claim 1, wherein the application controls the device itself.

3. The device according to claim 1, further being arranged for receiving the activation codes by reading at least one token (2).

4. The device according to claim 3, wherein each token (2) contains a single activation code (20).

5. The device according to claim 3, wherein the token (2) is re-writable.

6. The device according to claim 3, wherein the token (2) is an optical information carrier, preferably an SFFO disc.

7. The device according to claim 1, wherein the activation codes (20) are constituted by strings of alphanumeric characters each comprising a serial number and/or a version number.

8. The device according to claim 1, wherein the application is a software application executed by the device.

9. A toy comprising a device (1) according to claim 1, the toy preferably comprising an artificial pet.

10. A mobile telephone comprising a device (1) according to claim 1.

11. An optical information carrier (2) for use in a device (1) according to claim 1.

12. A method of de-activating an application (3) or a device (1), the method comprising:
receiving activation codes (20),
carrying out a check, for each activation code, whether the code was received in a predetermined order and within a certain time period, and
de-activating the application or the device if the check fails.

13. The method according to claim 12, wherein the device receives an activation code by reading a token (2).

14. The method according to claim 12, wherein the token (2) is an optical information carrier, preferably an SFFO disc.
